(19) United States
(12) Patent Application Publication
(10) Pub. No.: US 2007/0132740 A1
(43) Pub. Date: Jun. 14, 2007

(54) Tactile input device for controlling electronic contents

(76) Inventor: Linda Meiby, Lund (SE)

Correspondence Address: HARRITY SNYDER, L.L.P., Suite 600, 11350 Random Hills Road, Fairfax, VA, 22030, US

(21) Appl. No.: 11/431,630

(22) Filed: May 11, 2006

Related U.S. Application Data
(60) Provisional application No. 60/748,600, filed on Dec. 9, 2005.

(51) Int. Cl. G09G 5/00

(52) U.S. Cl. 345/173

(57) ABSTRACT

A tactile input device configured to control electronic contents of an electronic device includes a tactile key section and a scroll touch bar section. The input device provides a tactile user interface that is configured to allow a user to control aspects of an electronic device by tactile control.

### RELATED APPLICATIONS

This application claims priority under 35 U.S.C. § 119 based on U.S. Provisional Application Ser. No. 60/748,600, filed Dec. 9, 2005, the disclosure of which is incorporated herein by reference.

### FIELD OF THE INVENTION

This invention pertains in general to the field of input devices for electronic equipment. More particularly, the invention relates to a tangible input device for controlling electronic contents accessed by the electronic equipment, and even more particularly to a tactile input device for controlling media contents of mobile electronic equipment.

### BACKGROUND OF THE INVENTION

The popularity and use of mobile terminals or mobile telephones has skyrocketed through the past 20 years. People now take their mobile terminals with them everywhere and use them for a multitude of functions. In addition to making and receiving telephone calls, the mobile terminals also may function as music players, e.g., for the popular MP3 data format. Headphones connected to the body of the phone are both used for telephone calls and playback of audio contents from the phone.

With increased use of music players in phones, users expect a high level of user experience. For instance, a mobile phone having an integrated music player should provide easy access to a desired selection of music contents stored in the mobile phone or accessed via the mobile phone. Often, the user will use the mobile phone like a music player, i.e., the mobile phone will be in a pocket of the user's clothing. Being inside a pocket, it is an issue to control the music contents, e.g., to access the next song of a playlist comprising several pieces of music. It is inconvenient for the user to have to remove the mobile phone from the pocket, look at a displayed control selection and use a conventional input device of the mobile phone, such as a joystick, for scrolling through menus, etc. It is desired to immediately be able to control the accessed media contents, e.g., to be able to immediately adjust volume, switch off or pause music without having to look at device, i.e., taking it out of a pocket. On the mobile phone, this is difficult to achieve by using regular keys placed on the handset since these may be accidentally activated inside a pocket. Furthermore, keys are often made very small to fit on a small phone body, which contributes to complicating usability due to the amount of precision required and renders control of the phone difficult in general. Also, with traditional keys which are often similar, it is difficult to distinguish between keys to decide which to press without looking at them.

Hence, an improved way of controlling a mobile equipment such as a mobile phone would be advantageous and in particular, an input device for controlling functions of the mobile equipment allowing for increased user friendliness would be advantageous.

### SUMMARY OF THE INVENTION

According to an embodiment, a tactile input device is provided, which is configured to control electronic contents of an electronic device. The input device comprises a tactile key section, and a scroll touch bar section; and provides a tactile user interface that is configured to allow a user to control aspects of the electronic device by tactile control.

According to some embodiments, the tactile key section and said a scroll touch bar section may have at least one tactile reference element configured for controlling a music application run on said electronic device in use thereof.

According to some embodiments, the scroll touch bar may comprise a touch sensor with linear positioning and absolute positioning.

According to some embodiments, the scroll touch bar may be surrounded by a hardware frame for guiding a finger of a user to the scroll touch bar.

According to some embodiments, the scroll touch bar section may have an active area that is lowered into the aforementioned frame.

According to some embodiments, the tactile key section and the scroll touch bar section of the tactile input device may be located laterally at the electronic device.

According to some embodiments, the scroll touch bar section may be arranged in a slight concavity for guiding a fingertip on the scroll touch bar section.

According to some embodiments, the tactile key section and the scroll touch bar section of the tactile input device may be located separate from the electronic device.

According to some embodiments, the tactile input device may be located on a cord to an acoustic reproduction device.

According to some embodiments, the scroll touch bar section may have an elongated scroll area with tactile markings.

According to some embodiments, the tactile markings may be embossments elevating over the surface of the scroll area.

According to some embodiments, the tactile markings may comprise one first tactile marking that may be positioned in the centre of the scroll area, and at least one second tactile marking on each side of the first tactile marking along said scroll area.

According to some embodiments, the second tactile markings may be arranged at an increasing density with increasing distance from said first tactile marking.

According to some embodiments, the tactile key section and scroll touch bar section may be provided with tactile elements that are tactile distinguishable.

According to some embodiments, the tactile key section may comprise at least one toggle key recognizable by touch.

According to some embodiments, the at least one toggle key may be formed as an embossed symbol associated with the action accessed by a toggle key, respectively.

According to some embodiments, the at least one toggle key may be touch recognizing points in different sections along a linear touch sensor.

According to some embodiments, the electronic device may be configured to give audible feedback upon activation of a toggle key.

According to some embodiments, the tactile key section and the scroll touch bar section may be positioned on opposite sides of the tactile input device and wherein the tactile input device may be provided with a housing along a cord from the electronic device to a headphone, providing a remote music control for blind use.

According to some embodiments, the tactile key section and/or the touch bar section may be a linear touch sensor.

According to some embodiments, the tactile key section and/or the touch bar section may be divided into virtual sub sections along the linear touch sensor.

According to some embodiments, at least one of said linear sensors may be a resistive sensor.

According to some embodiments, at least one of said linear sensors may be a capacitive sensor.

According to some embodiments, at least a part of said input device may be coated with a waterproof, dust-proof and/or mud-proof material.

According to some embodiments, the electronic device may be a portable device.

According to some embodiments, the electronic device may be a mobile terminal, which comprises a portable or handheld mobile radio communication equipment, a mobile radio terminal, a mobile telephone, a smartphone, a communicator, or any other electronic device with wireless voice communication capabilities.

Some embodiments of the invention provide for accessing media contents by touch guidance only.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

These and other aspects, features and advantages of which the invention is capable will be apparent and elucidated from the following description of embodiments of the present invention, reference being made to the accompanying drawings, in which

FIG. 1 is a block diagram of a mobile terminal according to one embodiment of the invention;

FIG. 2 is a schematic view of an input device according to one embodiment of the invention;

FIG. 3 is a schematic view of an input device according to another embodiment of the invention;

FIG. 4 is a sectional view through an input device according to a further embodiment of the invention;

FIG. 5 includes perspective views of the input device according to FIG. 4; and

FIG. 6 is schematic illustration of an input device according to the embodiment of the invention shown in FIGS. 4 and 5 in use.

### DESCRIPTION OF EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

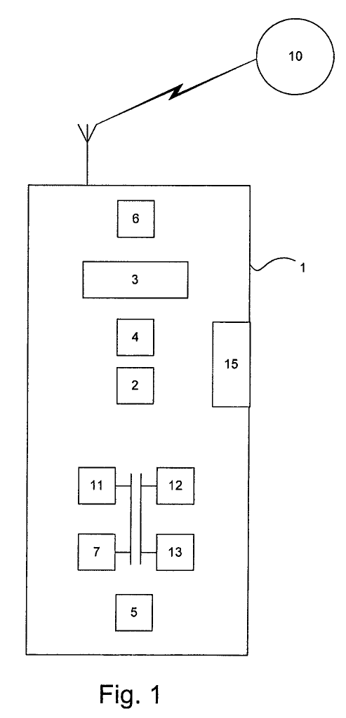

FIG. 1 illustrates a mobile terminal incorporating an input device according to some embodiments of the invention. The mobile terminal 1 may comprise a man-machine interface, such as a keypad 2, a display 3, a joystick 4, a microphone 5 and a loudspeaker 6, though which a user may interact with the mobile terminal 1. The mobile terminal 1 may be a portable or handheld mobile radio communication equipment, a mobile radio terminal, a mobile telephone, a communicator, a smartphone or any other electronic device with wireless voice or data communications capabilities. Thus, the mobile terminal 1 may be connected to a network 10.

The mobile terminal 1 may comprise various applications for carrying out functions within the mobile terminal 1. The applications may be provided within an operational platform. Alternatively or additionally, the applications may be provided within a communication platform. The operational platform may comprise systems software run by an application processor, such as a CPU (Central Processing Unit) 7, which may also be referred to as the ACPU (Application CPU). Similarly, the communication platform may comprise both hardware and software for carrying out, e.g., communication with the network 10. Thus, the communication platform may include a CPU, which may be referred to as a CCPU, (Communication CPU), for providing various applications. The ACPU and the CCPU may run different operational systems. Also, the communication platform and the operational platform may interact to exchange information. The mobile terminal 1 further comprises a transmitter 11 and a receiver 12 (or a transceiver) for sending and receiving signals to and from the network 10. A memory 13 is provided in mobile terminal 1 for instance for storing music electronically, e.g., as MP3 files. Furthermore, an input device 15 is provided for tactile control of some functions of mobile terminal 1.

Specific embodiments of input device 15 are given below. An advantageous control aspect of accessing media contents from a mobile phone, consistent with the invention, is provided by touch guidance only. An input device provides a tactile feedback to the user. The user feels with the finger touching the input device which selection is made when pressing an appropriate control section of the input device. The user does not have to look at the input device for the control action. Thus, a tactile interface allows a user to control aspects of an electronic device by tactile control.

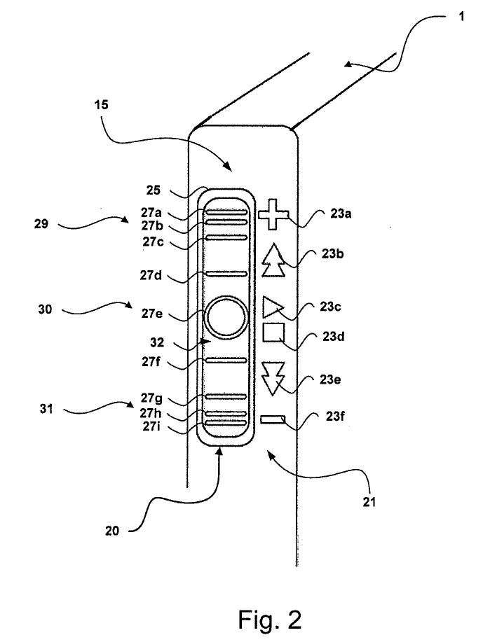

An embodiment of the input device 15 is given in FIG. 2. The input device comprises a scroll touch bar section 20 and a key section 21 with individual keys 23a-23f. Both scroll touch bar section 20 and key section 21 with individual keys 23a-23f are static devices, i.e., there are no mechanically moving elements like buttons of a keyboard.

Scroll touch bar section 20, also referred to herein as scroll touch bar 20, and key section 21 with individual keys 23a-23f provide tactile feedback to a user due to tactile elements 27a-27i and 23a-23f respectively. The tactile elements are embossed in relation to an underlying plane in order to be able to be sensed by touch.

In certain embodiments, the scroll touch bar section 20 improves user experience for using music players in a phone by introducing tactile references for controlling music application. In this way, visual contact with a control is not required for direct adjustment. The scroll touch bar 20 is built on a touch sensor with one dimensional (1D)/linear positioning (y-axis) and absolute positioning. The scroll touch bar 20 of the embodiment is surrounded by a hardware frame 25 for guiding a finger of a user to the scroll touch bar 20 and is placed on the side of a mobile phone 1. According to alternative embodiments, the scroll touch bar section 20 and key section 21 may be arranged differently, for instance on a separate box located on a cord of a handsfree set of a phone.

The active area of scroll touch bar 20 is, according to one embodiment, lowered into the aforementioned frame 25 for protection towards accidental activation. If placed on the side of the phone 1, as shown in FIG. 2, the scroll touch bar 20 may be arranged in a slight concavity for guiding a fingertip on the scroll bar. On the touch scroll area 32, tactile markings 27a-27i are given for guiding a user. For instance, the center of the scroll area 32 is indicated by a circular tactile marking 27e. The tactile markings 27a-27i are formed as embossments elevating over the surface of scroll area 32.

Tactile marking 27e may also have other forms, different than circular, and may indicate where the center of the select area 32 is, i.e., the middle thereof. The other tactile markings 27a-27d and 27f-27i may have an increasing density or acceleration associated therewith, depending on the distance from middle of the scroll touch bar 20, i.e., the density of tactile markings increases with increasing distance from the center of the scroll touch bar 20. This increasing density is tangible and a user may use this density of tactile markings in order to identify the current touching position on the scroll touch bar 20. This may, for instance, be used by a scrolling software being position dependent with relation to the scroll touch bar 20. Software behavior associated with controlling one or more functions (e.g., a scan function) may be made faster on the upper portion 29 and lower portion 31 in relation to the middle portion 30 of scroll touch bar 20, as described in more detail below.

According to an exemplary non-limiting embodiment, the tactile guides (e.g., tactile markings 27a-27i) are approximately 0.4 mm high and 1 mm wide for sufficient distinction by a fingertip. However, these dimensions may be chosen differently, as long as sufficient tactile distinction is given. It to be noted that the dimensions and proportions given in the attached drawings are not to be construed as being to scale and certain portions may be exaggerated for illustrative purposes only, such as, for instance, the length of the tactile input device in relation to the size of fingers, cords etc.

As already mentioned, a center select position may be indicated by an embossed circle or other tactile elements, which may be detected by touch. Various functions may be controlled by scroll touch bar 20. For instance, in a music device several factors may be managed by scrolling along scroll touch bar 20, as for instance, volume control, playlists and contents of individual tracks/songs. In order to differentiate between such different tasks, the scroll touch bar 20 is used for controlling these factors, one at a time. In order to toggle between the different factors, individual keys 23a-23f are arranged in addition to the scroll touch bar 20. Keys 23a-23f are arranged suitably, for instance as shown in FIG. 2 in parallel with the scroll touch bar 20 in order to be certain of which factor is activated. The toggle keys 23a-23f are recognizable by touch. For instance, keys 23a-23f are formed by embossing a symbol associated with the action accessed by activating a key. Keys 23a-23f need not be movable, but may be touch recognizing points in different sections along a linear touch sensor 21. Keys 23a-23f are tangible by tactile detection and guidance is given for blind use of input device 15.

Additionally each factor, such as volume, change track, etc., may be applied with different audible feedback sounds for distinguishing between the factors.

For instance, one embodiment may have three input keys in section 21. For instance, a first key may be for “volume”, a second key for “song list” and a third key for “fast scan”. A user feels the difference between those three buttons. The user presses, for instance, the volume button in order to select volume control. Then the resistive/conductive scroll touch bar 20 sensor functions as volume control. Similarly, if the user presses the “scan button”, then the scroll touch bar 20 sensor functions as, e.g., a fast forward control. The speed of the scan function may increase depending on how far out on the scroll touch bar 20 the finger is located, according to the above-mentioned speed or acceleration feature, when. listening to, e.g., a MP3 song. When selecting the “fast scan” key, channel scanning function up/down may be activated for the scroll touch bar 20 when the user is listening to a radio integrated in phone 1 and wants to select another radio station.

In some embodiments, the scroll touch bar 20 may be placed on a small box or enclosure located, for example, on a cord. This may thus create a remote music control device on a headset of a phone or on a side of a phone for in pocket use.

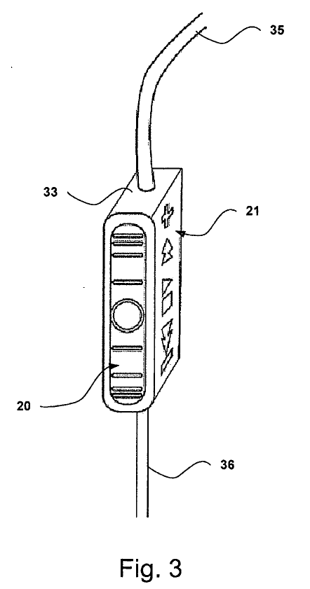

An embodiment having the scroll touch bar 20 and keys 23 arranged on a small box 33 connected to cord 35,36 is shown in FIG. 3. It can be seen that key section 21 is arranged on a side of the box 33 and scroll touch bar section 20 is arranged on a different side adjacent to the key section 21. Thus, a remote music control on a headset of a phone is formed, which enables easy touch control of the phone as explained above.

The technology of the touch sensor may for instance be resistive or capacitive. Capacitive sensors need the physical contact with a body part, as a finger, to actuate, and are generally safer for applications where accidental activation may happen during use, e.g., during pocket use. Capacitive sensors cannot be as easily accidentally activated by hits or presses from surroundings against the device. Resistive sensors do not need the physical contact with a body part, such as a finger, to actuate. Pressure on a resistive sensor is sufficient to activate the sensor. Moreover, a resistive sensor may be used as a simple (location dependent) switch, by having a threshold for the pressure needed for activating the sensor. In addition, the amount of pressure may be sensed by a resistive sensor. In this case, a resistive sensor is more sensitive against accidental activation, e.g., in pocket use. However, the resistive sensors enable additional features, as for instance using the amount of force applied on a bar as an indication for intended speed for scrolling. A user may thereby press harder for faster scrolling or lighten pressure for slowing scroll motion down. Also, resistive sensors may be used for touch control with, e.g., gloves on. In some embodiments, the sensor types may be used in combination or addition to each other, e.g., capacitive sensors on one side of the tactile input device, and resistive sensors on the other side of the device. In this case, activation or choice of operation mode may be selected by touching a capacitive sensor part of the device, and scrolling may be performed by pressing with more or less force on a resistive sensor part of the tactile input device.

Both types of sensors may be more or less advanced in terms of absolute positioning and resolution. For the scroll touch bar 20 embodiment discussed, only 1 dimensional positioning is required as compared with a touch screen which requires 2 dimensional positioning.

Capacitive sensors will generally require a more advanced software interface for control than resistive technologies and are somewhat more expensive. Capacitive sensors may also need to be covered with a special rubber/plastics material for creating induction between sensor and fingertip. The material and induction signal require a certain level of moisture from a finger and is somewhat temperature sensitive. Thus, this technology may not be used with gloves on, in low temperatures or in very dry situations.

Resistive sensors are generally less temperature sensitive, less expensive and may be covered with any material since only pressure is detected and contact with the actual sensor is not required.

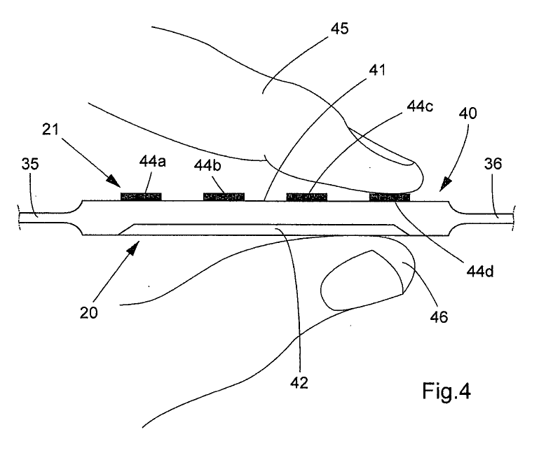

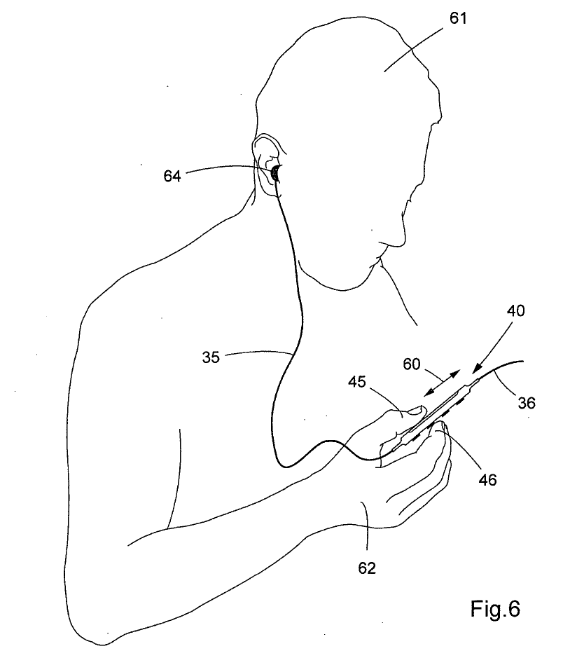

A further embodiment of the invention is illustrated in FIGS. 4-6. As illustrated in FIGS. 4, an input device 40 has arranged the scroll touch bar 20 and the key section 21 on opposite sides 41 and 42 of device 40. A user 62 is thus easily able to use input device 40, e.g., as illustrated in FIG. 6 by arrow 60. For example, a user presses the appropriate icon 44a, 44b, 44c, 44d detected by touch with a first finger 45 and drags a second finger 46 on the other side of the input device 40, where a second sensor is used for, e.g., to control volume, change tracks, etc. Icons 44a, 44b, 44c and 44d are embossed so that they can easily be sensed by touch with a finger. Furthermore, the contoured shapes of each of icons 44a, 44b, 44c, and 44d may be different, so that a user is easily able to identify a certain one of icons 44a, 44b, 44c, 44d for activation with a finger. In the example of FIG. 4, icon 44c is sensed by finger 45 and used for selecting a desired control. In this exemplary embodiment, icon 44d has a round contour shape and may, e.g., be associated with a selected “change track” function. Finger 46 then scrolls along sensor 20 in order to change tracks. Alternatively another key having a different contour shape may be selected by finger 45, e.g., icon 44a may, e.g., be associated with a selected “play” function and finger 46 then scrolls along sensor 20 in order to fast forward or fast rewind within a track. Icon 44b may, e.g., be associated with a selected “volume control” function and finger 46 then scrolls along sensor 20 in order to raise or lower the current volume in earplug 64.

According to an embodiment of device 40, icons 44a are approximately at least 0.4 mm embossed in order to provide tactile feedback. Scroll touch bar 42 is debossed in some embodiments, similar to the above-described embodiment shown in FIG. 2.

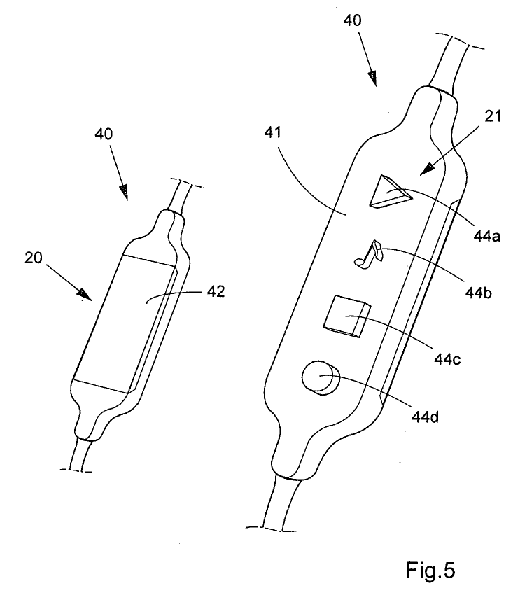

FIG. 5 includes perspective views of the input device according to FIG. 4, wherein device 40 is shown with one side to the viewer on the left in FIG. 5 and turned by 180 degrees on the right in FIG. 5. As illustrated, the embossment of icons 44a-d and their contoured shapes are clearly shown in the exemplary embodiment illustrated in FIG. 5. FIG. 6 is schematic illustration of an input device according to the embodiment of the invention shown in FIGS. 4 and 5 in use, as described above. Touch scroll area 42 is only schematically illustrated in FIGS. 4-6. However, according to some embodiments, even here the embossments on the scroll area may be implemented in accordance with tactile elements 27a-27i described above and shown in FIGS. 2 and 3.

The whole device 40 may be made very thin, based on, among other things, sensor space saving abilities. Thus, the device may be easily transported and will not weigh down a cord when mounted in, such a configuration (e.g., the configuration illustrated in FIG. 3). The device is very user friendly, conveniently available for use and manufacturable at low cost.

As mentioned above, the scroll touch bar 20 or 42 is built on a touch sensor with 1D/linear positioning (y-axis) and absolute positioning. By means of a touch sensor with one dimensional linear positioning, the input device may be implemented with two such sensors, wherein the input device comprises a scroll touch bar section 20 and a key section 21 with individual keys 23a-23f. However, keys 23a-23f are implemented by means of a single linear touch sensor that provides the position of activation along its longitudinal axis. In this way, key section 21 may be divided into virtual sub sections, each associated with one of keys 23a-23f, respectively. Then, the user easily tangibly identifies the corresponding section and the sensor indicates the longitudinal position, thus enabling association with the key within the sub-section. The same applies to scroll touch bar section 20 which may be divided into virtual sub-sections in order to associate tactile elements 27a-27i with a linear position on the sensor implementing section 20.

A further embodiment may comprises a certain longitudinal section of a touch screen having tactile recognizable elements on its surface for implementing a scroll touch bar section and a key section with individual keys. The tactile elements may be implemented by suitable embossments in the screen surface. In this way, a screen may even be used for input to an electronic device without looking at it, thus providing a dual function of the touch screen. In addition, the touch screen may be provided with an active direct mechanical feedback that simulates the feeling of pressing a key. One such technology suitable for such a feedback is the Sony Motion Engine that gives direct feedback to the activating finger that a tactile element has been activated.

The input device may be coated at least partly in a suitable way according to some embodiments. A coating covering the input device 15 then, for instance, completely seals and protects the input device 15. The coating may, for instance, be composed of a waterproof, dust-proof and mud-proof material whereby the input device 15 may be operated in an outdoor condition without risk of damage. By sealing the sensor, risk for incoming dirt to cause quality problems on a sensor is very limited.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, a “mobile terminal” includes both devices having only a wireless signal receiver without transmit abilities and devices having both receive and transmit hardware capable of two-way communication over a two-way communication link. Such devices may include cellular or other communications devices with or without a multi-line display; Personal Communications System (PCS) terminals that may combine a voice and data processing, facsimile and/or data communications capabilities; Personal Digital Assistants (PDA) that can include a radio frequency receiver and a pager, Internet/Intranet access, Web browser, organizer, calendar and/or a global positioning system (GPS) receiver; and/or conventional laptop and/or palmtop computers or other appliances, which include a radio frequency receiver. As used herein, “mobile terminal” may be portable, transportable, installed in a vehicle (aeronautical, maritime, or land-based), or situated and/or configured to operate locally and/or in a distributed fashion at any other location(s) on earth and/or in space.

The present invention has been described above with reference to specific embodiments. However, embodiments other than the above described are equally possible within the scope of the invention. Different method steps than those described above, performing the method by hardware or software, may be provided within the scope of the invention. The different features and steps of the invention may be combined in other combinations than those described. The scope of the invention is only limited by the appended patent claims.

What is claimed is:

1. A tactile input device configured to control electronic contents of an electronic device, said input device comprising:
a tactile user interface comprising:
a tactile key section, and
a scroll touch bar section;
the tactile user interface being configured to allow a user to control aspects of the electronic device by tactile control.

2. The tactile input device according to claim 1, wherein said tactile key section and said scroll touch bar section have at least one tactile reference element configured for controlling a music application run on said electronic device.

3. The tactile input device according to claim 1, wherein the scroll touch bar section comprises a touch sensor with linear positioning and absolute positioning.

4. The tactile input device according to claim 1, where the scroll touch bar section is surrounded by a hardware frame for guiding a finger of a user to the scroll touch bar section.

5. The tactile input device according to claim 4, wherein the scroll touch bar section has an active area that is lowered into the frame.

6. The tactile input device according to claim 1, wherein the tactile key section and the scroll touch bar section of the tactile input device are located laterally at the electronic device.

7. The tactile input device according to claim 6, wherein the scroll touch bar section is arranged in a slight concavity for guiding a fingertip on the scroll touch bar section.

8. The tactile input device according to claim 1, wherein the tactile key section and the scroll touch bar section are located separately from the electronic device.

9. The tactile input device according to claim 8, wherein the tactile input device is located on a cord to an acoustic reproduction device.

10. The tactile input device according to claim 1, wherein the scroll touch bar section has an elongated scroll area with tactile markings.

11. The tactile input device according to claim 10, wherein the tactile markings are embossments elevating over the surface of the scroll area.

12. The tactile input device according to claim 11, wherein the tactile markings comprise one first tactile marking that is positioned in the center of the scroll area, and at least one second tactile marking on each side of the first tactile marking along said scroll area.

13. The tactile input device according to claim 12, wherein the at least one second tactile marking comprises a plurality of second tactile markings arranged at an increasing density with increasing distance from said first tactile marking.

14. The tactile input device according to claim 1, wherein tactile key section and scroll touch bar section are provided with tactile elements that are tactile distinguishable.

15. The tactile input device according to claim 1, wherein the tactile key section comprises at least one toggle key recognizable by touch.

16. The tactile input device according to claim 15, wherein the at least one toggle key is formed as an embossed symbol associated with the action accessed by a toggle key, respectively.

17. The tactile input device according to claim 15, wherein the at least one toggle key are touch recognizing points in different sections along a linear touch sensor.

18. The tactile input device according to claim 15, wherein said electronic device is configured to give audible feedback upon activation of a toggle key.

19. The tactile input device according to claim 15, wherein the tactile key section and the scroll touch bar section are positioned on opposite sides of the tactile input device and wherein the tactile input device is provided with a housing along a cord from the electronic device to a headphone, providing a remote music control for blind use.

20. The tactile input device according to claim 1, wherein at least one of the tactile key section or the scroll touch bar section is a linear touch sensor.

21. The tactile input device according to claim 20, wherein at least one of the tactile key section or the scroll touch bar section is divided into virtual sub sections along the linear touch sensor.

22. The tactile input device according to claim 20, wherein at least one of said linear touch sensors is a resistive sensor.

23. The tactile input device according to claim 20, wherein at least one of said linear touch sensors is a capacitive sensor.

24. The tactile input device according to claim 1, wherein at least a part of said input device is coated with at least one of a waterproof, dust-proof or mud-proof material.

25. The tactile input device according to claim 1, wherein the electronic device is portable.

26. The tactile input device according to claim 25, wherein the electronic device is a mobile terminal.

27. The tactile input device according to claim 26, wherein the mobile terminal is a mobile telephone.
